(19) United States
(12) Patent Application Publication
(10) Pub. No.: US 2026/0285617 A1
(43) Pub. Date: Sep. 24, 2026

(54) CLAMPING DEVICE

(71) Applicant: KRONES AG, Neutraubling (DE)

(72) Inventor: Markus SCHOENFELDER, Regensburg (DE)

(21) Appl. No.: 19/570,457

(22) Filed: Mar. 18, 2026

(30) Foreign Application Priority Data
Mar. 18, 2025 (DE) 10 2025 110 484.0

(51) Int. Cl. B65G 47/90; B25J 15/04

(52) U.S. Cl. CPC B65G 47/90; B25J 15/0475

(57) ABSTRACT

The invention relates inter alia to a clamping device for holding a container at a support ring of the container for a container transport and/or container processing apparatus. The clamping device comprises a clamping arm pair having two clamping arms which can be moved, preferably pivoted, relative to one another, for supporting the support ring of the container from below. The clamping device also comprises a centering element for centering the container. The centering element is arranged between the clamping arm pair and has a receptacle for receiving and supporting part of the support ring.

### CROSS-REFERENCE TO RELATED APPLICATIONS

This application claims the benefit under 35 U.S.C. § 119(a) of German Patent Application No. DE 10 2025 110 484.0, filed Mar. 18, 2025, entitled CLAMPING DEVICE, and whose entire disclosure is incorporated by reference herein.

### TECHNICAL FIELD

The invention relates to a clamping device and a container processing apparatus having a clamping device. The invention further relates to an associated method.

### TECHNICAL BACKGROUND

DE 10 2020 114 905 A1 relates to an apparatus for holding a container in a container processing apparatus, comprising two gripping arms, which can be pivoted relative to one another in a pivoting plane and each of which has a holding section for holding the container to be held. A lifting rod is coupled to the gripping arms such that the holding sections can be pivoted relative to one another by a displacement of the lifting rod perpendicular to the pivoting plane of the gripping arms. The gripping arms are each arranged on a holder so as to be pivotable about a pivot axis formed by a mechanical shaft.

DE 10 2022 122 939 A1 likewise relates to an apparatus for holding a container, which apparatus can significantly simplify assembly and disassembly.

Reference is made to DE 20 2022 105 105 U1, DE 10 2008 055620 A1, DE 10 2008 029711 A1, DE 10 2019 128335 A1, US 2009/315281 A and CN 112728259 A as further prior art.

A disadvantage of known container clamps can be that the centering of the container has to be achieved through accurate and complex adjustment of the clamping arms. Furthermore, for example a closure apparatus must be elaborately adjusted to ensure that the closing of the container clamp (timely and synchronous closing of the clamping arms requires considerable complexity and technical demands today) and the closing of the container proceed in such a way that, during transfer and closing, the container is not lost or damaged and the closure is not applied incorrectly.

The object of the invention is to create improved technology for holding containers. Preferably, the technology should enable low-adjustment and particularly accurate positioning of the held container, e.g., in combination with processing, preferably closure, of the held container.

### SUMMARY OF THE INVENTION

The object is achieved by the features of independent claim 1. Advantageous developments are specified in the dependent claims and the description.

One aspect relates to a clamping device, preferably a neck handling clamping device, for holding a container (e.g., a bottle, e.g., a PET bottle) at a support ring of the container for a container transport and/or container processing apparatus. The clamping device comprises a clamping arm pair having two clamping arms which can be moved, preferably pivoted (swiveled), relative to one another, for supporting the support ring of the container from below. The clamping device comprises a centering element for centering the container, wherein the centering element is arranged between the clamping arm pair and comprises a receptacle for partially receiving and supporting of the support ring.

The clamping device can advantageously enable container centering at the center of the clamping device and simple receiving of the container. The container can be easily transferred into the receptacle without being or sliding out of center and without the need for exact adjustment of the closing of the clamping arms. Centering can advantageously be carried out directly on the support ring of the container neck. The support ring of the container is already exact in the preform. This means that container centering on the support ring is particularly dependable and reliable. In contrast, the cylindrical diameter of the container below the support ring is determined by the diameter and shaping in the bottle-blowing process and is therefore less precise. The centering element thus advantageously allows for particularly accurate positioning of the container. For example, for container processing, such as in the process of closing the container, the container can be reliably positioned by the clamping device such that the container is centered below the processing device. For holding and centering, the container must advantageously be contacted by the clamping device only laterally and from below at the support ring. Advantageously, this allows the support ring to remain free above, which enables great flexibility regarding the configuration of the associated processing device, e.g., closure head. Advantageously, this means that, for example, there is no impairment due to the support ring centering during the closure process.

Preferably, the centering element can be arranged centrally between the two clamping arms and/or substantially at the same height as the two clamping arms.

In one exemplary embodiment, at least one of the following is fulfilled:
the centering element is immovably fastened to a support part of the clamping device (e.g., for mounting the clamping device), preferably from below;
the centering element is immovably arranged between the clamping arm pair; and
the centering element and the receptacle are configured and arranged for centered positioning of the container between the two clamping arms.

Advantageously, a robust and reliable construction which has low susceptibility to wear and which enables reliable centering of the container can thus be ensured.

In a further exemplary embodiment, at least one of the following conditions is met:
the receptacle is ring-segment-shaped;
the receptacle forms a forked section of the centering element;
the receptacle is shaped to partially extend around of an outer lateral face of the support ring;
the receptacle is formed as a step or a shoulder on the centering element;
the receptacle is arranged on a front face of the centering element; and
the receptacle is arranged on a top side of the centering element.

Advantageously, the receptacle can thus be of simple construction and also can enable reliable receiving and centering of the support ring or the container.

In one embodiment, the receptacle has a preferably ring-segment-shaped base face for supporting the support ring from below and/or a preferably ring-segment-shaped side wall face for supporting the support ring laterally. Advantageously, the receptacle can support (or contribute to the supporting of) the container using the base face and can center the container using the side wall face.

In a further embodiment, at least one of the following conditions is met:
the side wall face is shaped substantially as a segment of a lateral face of a conical frustum;
the side wall face protrudes (e.g., over the base face); and
the side wall face and the base face are angled relative to one another in order to clamp the support ring between the base face and the side wall face, e.g., at an angle <90°.

Advantageously, this allows for simple torque support or prevention of rotation of the container held at the support ring, which, for example, can be particularly advantageous in the case of (simultaneous) processing (e.g., closing) of the container. Advantageously, the necessary counter holding forces on the support ring, e.g., for closing, can be achieved by a protrusion/conical shape of the side wall face. The container can be advantageously pressed into the side wall face by planar faces (e.g., contact faces of the supporting sections and/or blunt holding parts) of the clamping arms in order to significantly increase friction and counteract the closing torque.

Advantageously, it is then no longer necessary, for example, to use engagement elements for cutting into the container to prevent the container from rotating. A major advantage here can be that the container is not damaged when closing it. Advantageously, the side wall face can also ensure that the container cannot tilt and thus assumes a perfect position for the processing, e.g., closing, of the container, so that there are hardly any processing errors in the process.

In one embodiment variant, the two clamping arms each have a preferably curved and/or hook-shaped supporting section for supporting the support ring (e.g., laterally and/or from below).

In a further embodiment variant, at least one of the following conditions is met:
the supporting section of each clamping arm is arranged at a free end of the respective clamping arm;
the supporting sections are directed towards the receptacle;
the supporting sections each have a top supporting face (which, for example, is substantially rectangular) for supporting the support ring from below; and
the supporting sections each have (e.g., on a front face) a vertically oriented (e.g., substantially rectangular) contact face for contacting a neck region of the container directly below the support ring in order to press the support ring into the receptacle of the centering element.

Advantageously, the clamping arms can thus both support (or contribute to the supporting of) the container and assist with centering.

In one exemplary embodiment, at least one of the following is fulfilled:
the supporting faces are arranged at the same height as a base face of the receptacle of the centering element; and
the contact faces are directed towards the receptacle.

Advantageously, this allows for the container to be supported at the support ring jointly by the supporting faces and the base face. The contact faces can enable the clamping arms to assist with centering and, optionally, clamping.

In a further exemplary embodiment, the two clamping arms each comprise a clamping arm body and/or (at least) one engagement element, preferably cutting element (e.g., cutting plate) or spike, wherein the engagement elements are configured to engage in, preferably cut into, the container (e.g., into a neck region directly below the support ring).

Advantageously, the engagement elements can allow for simple torque support or prevention of rotation of the container held at the support ring, which, for example, can be particularly advantageous in the case of (simultaneous) processing (e.g., closing) of the container.

In one embodiment, at least one of the following conditions is met:
the engagement element of each clamping arm is detachably fastened to or in the clamping arm body of the respective clamping arm (e.g., by screw connection);
the engagement elements are identical parts;
the engaging elements are held in a receiving hole of the clamping arm body of the respective clamping arm in a form-fitting manner that prevents them from rotating;
the engagement elements are arranged opposite one another;
the engaging elements are each connected to the clamping arm body in a sealed manner by means of a sealing element;
the engagement elements are arranged at a height below a base face of the receptacle of the centering element for engagement in a neck region of the container directly below the support ring;
the engagement elements are arranged on a longitudinal inner side of the clamping arm body of the respective clamping arm; and
the engagement elements are arranged at a distance from a free end of the respective clamping arm.

Advantageously, this allows for reliable functioning of the engagement elements. Additionally, the sealing elements can advantageously enable a particularly hygienic construction. The detachability of the engagement elements allows for simple, quick and cost-effective replacement of the engagement elements when this is necessary, for example due to wear, advantageously without having to replace the entire clamping arms or more. The arrangement of the engagement elements can ensure that imprints, such as notches or cut marks, of the engagement elements are produced only directly below the support ring, where they are not visible or hardly visible and do not impair any functional region, such as the support ring itself, of the container.

A further aspect relates to a (e.g., rotary) container processing apparatus, preferably a (e.g., rotary) container closure apparatus for closing containers (e.g., bottles, e.g., PET bottles). The container processing apparatus comprises at least one processing station, preferably closure station, having a processing device, preferably a closure head, and having a clamping device as disclosed herein. Preferably, the receptacle of the centering element can be arranged for positioning the container such that the container is centered below the processing device.

Advantageously, the container processing apparatus can achieve the same advantages as already described with reference to the clamping device. Advantageously, the lateral gripping using the clamping arms also makes it possible for the clamping device to work together with a closure head that closes without head pressure.

A further aspect of the present disclosure relates to a container processing plant (e.g., for controlling the temperature, producing, cleaning, coating, testing, filling, closing, pasteurizing, decorating, labeling, printing, marking, laser marking, and/or packaging containers for liquid or pasty media, preferably beverages, liquid foods or products from the pharmaceutical or healthcare industry). The container processing plant can comprise the clamping device as disclosed herein or the container processing apparatus as disclosed herein. The container treatment system can, for example, be a beverage filling plant.

A further aspect relates to a method for operating a clamping device as disclosed herein or a container processing apparatus as disclosed herein. The method comprises the following:
holding (and optionally supporting) a container (e.g., a bottle, e.g., a PET bottle) at a support ring, preferably neck ring, of the container using the clamping device, wherein the two clamping arms support the support ring from below and the support ring is partially received in the receptacle of the centering element.

Advantageously, the method can achieve the same advantages as already described herein with reference to the clamping device and the container processing apparatus. The same applies to the preferred exemplary embodiments of the method explained in the following.

In one exemplary embodiment, the method further comprises:
positioning the container such that the container is centered between the two clamping arms and/or centered below a processing device, preferably a closure head for closing the container, by applying, preferably pressing (e.g., as a result caused by the two clamping arms), an outer lateral face of the support ring against a side wall face of the receptacle; and optionally
processing, preferably closing, the held and positioned container using the processing device.

In a further exemplary embodiment, the method also comprises preventing the held container from rotating by at least one of the following:
clamping the support ring between a side wall face of the receptacle and a base face of the receptacle, preferably with a side wall face of the receptacle which is substantially in the shape of a segment of a lateral face of a conical frustum and/or with a protruding side wall face; and
engaging in, preferably cutting into, the container using engagement elements (e.g., cutting elements (e.g., cutting plates) or spikes) of the two clamping arms, preferably directly below the support ring.

In another exemplary embodiment, the method further comprises the following:
replacing engagement elements (e.g., cutting elements (e.g., cutting plates) or spikes) for engaging in, preferably cutting into, the container to prevent the container from rotating, the engagement elements being detachably fastened to clamping arm bodies of the two clamping arms; and optionally
sealing between the engagement elements and the clamping arm bodies using at least one sealing element.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 shows a schematic representation of a container transport and/or container processing apparatus according to an exemplary embodiment;

FIG. 2 shows a perspective side view of a section of an exemplary processing station having a clamping device according to an exemplary embodiment and having a purely schematically represented closure head;

FIG. 3 shows a perspective view from above of the exemplary clamping device in an open position;

FIG. 4 shows a perspective view from above of the exemplary clamping device in a closed position (representation without container);

FIG. 5 shows a perspective view from below of the exemplary clamping device;

FIG. 6 shows a sectional view through the exemplary clamping device;

FIG. 7 shows a partially exploded representation of the exemplary clamping device; and

FIG. 8 shows a partially exploded representation of the exemplary clamping device.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

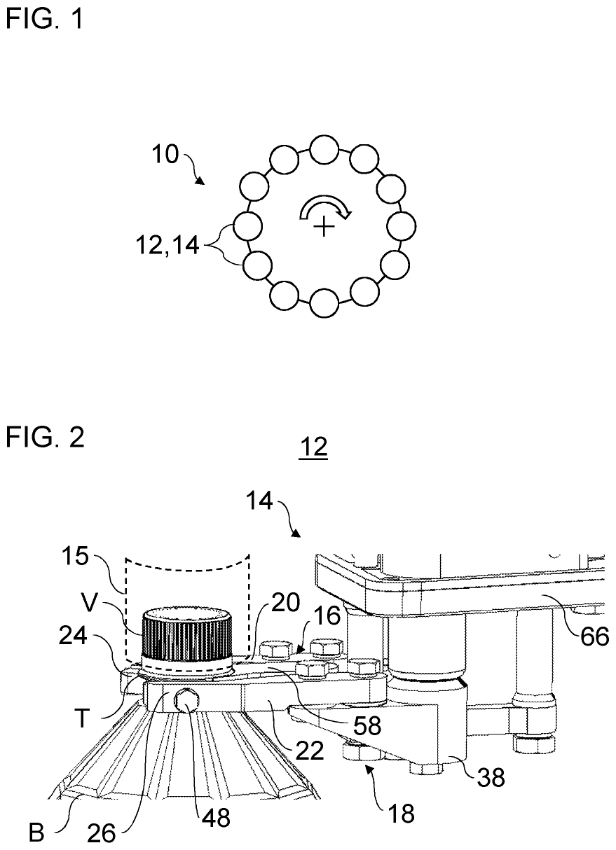

FIG. 1 purely schematically shows a container transport and/or container processing apparatus 10. The apparatus 10 can preferably be implemented as a rotary apparatus or in carousel structure, or as a linear apparatus.

Preferably, the apparatus 10 has several stations 12 for handling and, optionally, processing several containers simultaneously or with temporal overlap. Preferably, the stations 12 are processing stations at/in which the containers are processed, e.g., closed. The stations 12 can be distributed around a circumference of the apparatus 10 configured as a carousel or rotary machine. Each station 12 can have a clamping device 14.

Particularly preferably, the apparatus 10 is a closure apparatus for closing containers, e.g., with a lid, a cork, a crown cap or a screw cap. For example, the closure apparatus can be a PET bottle closure apparatus. The closure apparatus can preferably be configured as a rotary closure apparatus. The closure apparatus can have several closure stations for closing several containers simultaneously or with temporal overlap. Each closure station can comprise a clamping device 14. For example, the closure stations and the clamping devices 14 thereof can be distributed around a circumference of the closure apparatus configured as a closure carousel. With respect to a container flow, the closure apparatus can be arranged downstream of a filling apparatus for filling the containers with contents, for example liquid or pasty contents.

FIG. 2 shows, by way of example, the clamping device 14 and a purely schematically indicated closure head 15 as a preferred example of a container processing device of a (processing) station 12. The closure head 15 can apply a container closure V to the container B, preferably by screwing the container closure on, while the container B is held by the clamping device 14.

The exemplary clamping device 14 is described below with reference to FIGS. 2 to 8, which show different views of the exemplary clamping device 14.

The clamping device 14 can also be referred to as a gripper device, preferably a side gripper device. The clamping apparatus 14 is configured to hold a container B (shown only in FIGS. 2 and 6). The clamping device 14 is preferably configured to hold the container B in the region of the support ring T of the container (shown only in FIGS. 2 and 6). Preferably, the support ring T is arranged in the neck region of the container B. The clamping device 14 can accordingly also be referred to as a neck handling clamping device.

The clamping device 14 has a clamping arm pair 16, 18 and a centering element 58 having a receptacle 60.

The clamping arm pair 16, 18 is formed by two clamping arms 16 and 18. The clamping arms 16, 18 can jointly hold the container B between them. Preferably, the clamping arms 16, 18 can support the support ring T of the container B from below.

The clamping arms 16, 18 can also be referred to as gripper arms. The clamping arms 16, 18 can substantially be oriented in a common horizontal plane.

The two clamping arms 16 and 18 are movable relative to each other for holding and releasing a container B. Preferably, the clamping arms 16 and 18 can be moved in opposite directions to each other.

Preferably, the clamping arms 16 and 18 are pivotable (swivelable). Preferably, the clamping arms 16 and 18 can be pivoted in opposite directions to each other. Preferably, the clamping arms 16 and 18 can be pivoted about pivot axes which are spaced apart parallel to each other. The pivot axes can preferably extend vertically.

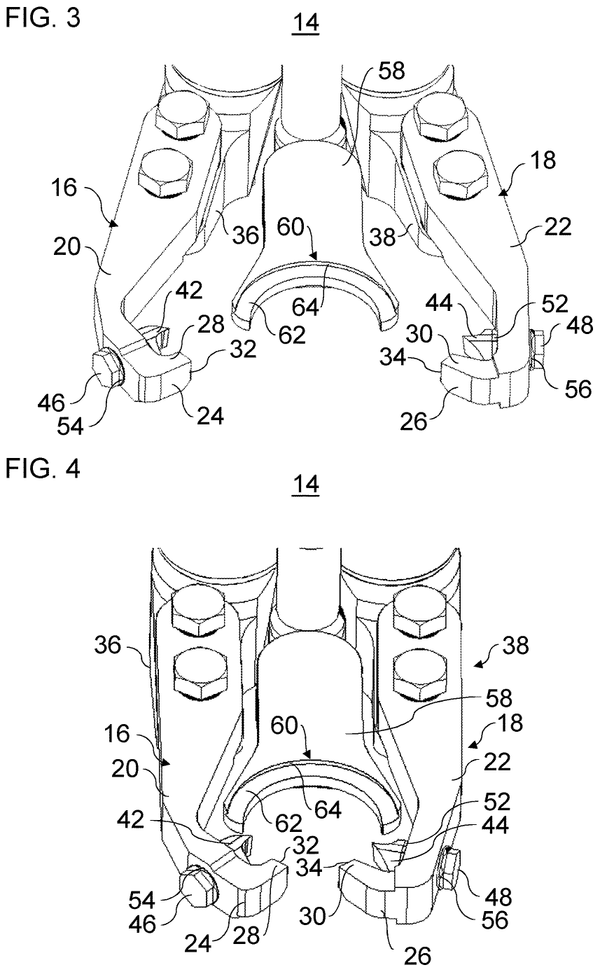

Preferably, the clamping arms 16 and 18 can be movable, preferably pivotable, between an open position/release position (see FIG. 3) and a closed position/holding position (see FIG. 4).

The clamping arms 16, 18 can be in single-part form or—as shown in FIGS. 2 to 8—preferably in multipart form.

For example, the clamping arms 16, 18 can each have a clamping arm body 20, 22 and, for example, a connecting body 36, 38. Optionally, the clamping arms 16, 18 can each have at least one engagement element 42, 44.

The container B can be contacted and held by the clamping arm bodies 20, 22, preferably in the neck region of the container B, e.g., at the support ring T of the container B.

Specifically, the clamping arm bodies 20, 22 can preferably each have a supporting section 24, 26 for supporting the support ring T. Each supporting section 24, 26 can be arranged at a free end of the particular clamping arm 16, 18. The supporting sections 24, 26 can be curved, preferably hook-shaped. Preferably, the curvature can be directed inwards, e.g., towards the centering element 58. For example, each supporting section 24, 26 can be curved at an angle ≥90°with respect to an adjacent section of the particular clamping arm body 20, 22. The supporting sections 24, 26 can be directed towards the receptacle 60 of the centering element 58.

Preferably, the supporting sections 24, 26 can each have a top supporting face 28, 30. The support ring T can be supported from below by the supporting faces 28, 30. Specifically, an underside of the support ring T can rest on the supporting faces 28, 30 when a container B is held by the clamping device 14. The supporting faces 28, 30 can, for example, be substantially rectangular. The supporting faces 28, 30 can preferably be oriented horizontally. Preferably, the supporting faces 28, 30 can be arranged at the same height as a base face 62 of the receptacle 60 of the centering element 58 or lie in a common horizontal plane with the base face 62 of the receptacle 60 of the centering element 58.

Preferably, the supporting sections 24, 26 can each have a contact face 32, 34 for contacting a neck region of the container B directly below the support ring T. Each contact face 32, 34 can preferably be arranged at a front face of the particular supporting section 24, 26 or particular clamping arm body 20, 22. The contact faces 32, 34 can, for example, be substantially rectangular. The contact faces 32, 34 can preferably be oriented vertically. The contact faces 32, 34 can be directed towards the receptacle 60.

The container B can be pressed by the contact faces 32, 34 towards the centering element 58, and thus part of the support ring T can be pressed into the receptacle 60 of the centering element 58.

Each contact face 32, 34 can adjoin the end face 28, 30 of the particular supporting section 24, 26. Preferably, the angle between the contact face 32 or 34 and the supporting face 28 or 30 can be approximately 90°.

Each clamping arm body 20, 22 can be fastened (e.g., detachably) to the connecting body 36, 38 of the particular clamping arm 16, 18. Preferably, the clamping arm bodies 20, 22 can be screwed to the respective connecting bodies 36, 38. Each clamping arm body 20, 22 can rest on a top side of the particular connecting body 36, 38. Alternatively, the clamping arm body 20 and the connecting body 36 could, for example, be formed integrally as a single piece, and the clamping arm body 22 and the connecting body 38 could, for example, be formed integrally as a single piece.

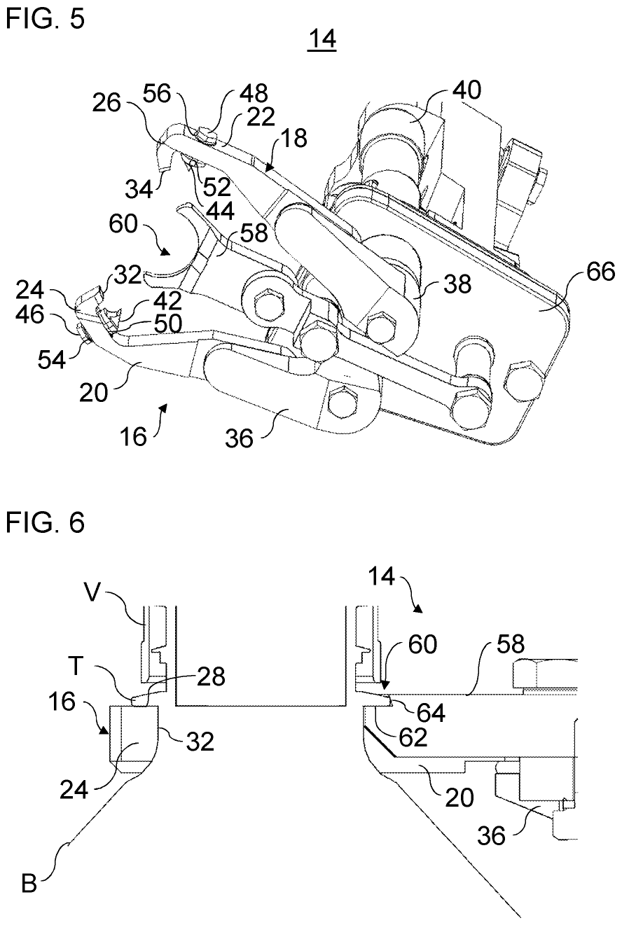

The connecting bodies 36, 38 can connect the clamping arm bodies 20, 22 to one shaft 40 each (see FIG. 5, in which one of the shafts 40 is visible by way of example). The clamping arms 16, 18 can be pivotable by the shafts 40. Rotation of the shafts 40 can cause the clamping arms 16, 18 to pivot. Preferably, longitudinal axes of the shaft 40 can be pivot axes of the clamping arms 16, 18. The pivot axes and the longitudinal axes can be substantially vertically oriented. The shafts 40 can extend parallel to one another. Rotation of the shafts 40 can be caused by an actuating device. The actuating device can be configured in any way, e.g., as in EP 4 335 784 A1, which is incorporated herein by reference with regard to the configuration of the actuating device and the suspension.

The connecting body 36 can support the clamping arm body 20. The connecting body 38 can support the clamping arm body 22. The connecting bodies 36, 38 can be fastened to the respective shafts 40, e.g., from below. For example, the connecting bodies 36, 38 can be fastened, preferably screwed, to the respective shafts 40 by one fastening element (e.g., screw) each (see FIG. 5).

The engagement elements 42, 44 can engage in the container B to secure the container B. The engagement elements 42, 44 can serve to provide torque support to the container B or to prevent the container from rotating, e.g., when the container is being processed, preferably closed.

Preferably, the engagement elements 42, 44 can engage in the container B when the clamping device 14 is in a closed position. For example, the engagement elements 42, 44 can cut into the container B. For example, the engagement elements 42, 44 can be configured as cutting elements (e.g., with one or more cutting edges or cutting tips) or as spikes. Preferably, the engagement elements 42 and 44 are identical parts.

It is also possible that, instead of engaging in the container B, the engagement elements 42, 44 are configured, for example, as blunt holding parts.

The engagement elements 42, 44 can preferably be arranged at a height below a base face 62 of the receptacle 60 of the centering element 58. Thus, the engagement elements 42, 44 can engage in a neck region of the container B directly below the support ring T. The engagement elements 42, 44 are preferably arranged opposite one another.

Preferably, each engagement element 42, 44 can be arranged on a longitudinal inner side of the particular clamping arm 16, 18 or clamping arm body 20, 22. Preferably, each engagement element 42, 44 can be arranged at a distance from a free end of the particular clamping arm 16, 18. For example, each engagement element 42, 44 can be set back from and/or arranged next to the supporting section 24, 26 of the clamping arm body 20, 22 of the particular clamping arm 16, 18.

Preferably, each engagement element 42, 44 is detachably fastened to or in the clamping arm body 20, 22 of the particular clamping arm 14, 16, e.g., by a screw connection. Accordingly, the engagement elements 42, 44 can be replaced, for example due to wear.

For example, a fastening element 46 can fasten the engagement element 42 to/in the clamping arm body 20. A further fastening element 48 can fasten the further engagement element 44 to/in the further clamping arm body 22. The fastening elements 46, 48 can, for example, be screwed directly into the engagement elements 42, 44. The fastening elements 46, 48 are preferably in the form of screws.

The screw head of each fastening element 46, 48 can be arranged on a longitudinal outer side of the particular clamping arm 16, 18 or clamping arm body 20, 22. This advantageously allows for good accessibility for installation and removal of the engagement elements 42, 44.

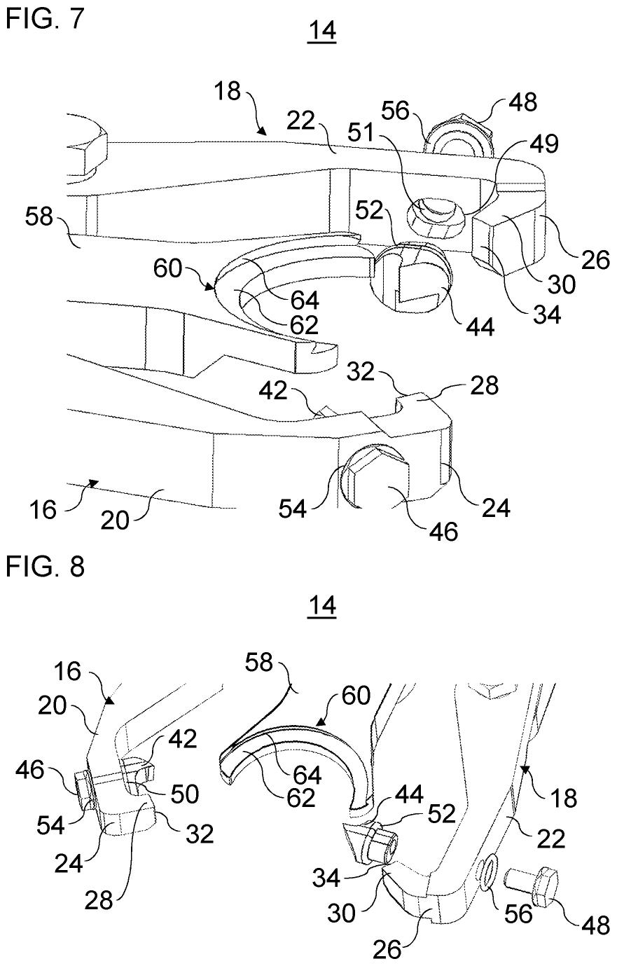

Preferably, each engagement element 42, 44 can be form-lockingly held in a receiving hole 49 (see FIG. 7) of the clamping arm body 20, 22 of the particular clamping arm 16, 18 in such a way that the engagement element is prevented from rotating. For example, the receiving hole 49 can have a cross section different from a circle, and the engagement element 42, 44 can have a holding section arranged in the particular receiving hole 49, which holding section is adapted to the cross section of the receiving hole 49, e.g., corresponds to the cross section of the particular receiving hole 49. For example, the receiving hole 49 can be an elongate hole or have an oval or rectangular cross section.

Preferably, a fastening hole 51 (see FIG. 7) of the clamping arm body 20, 22 of the particular clamping arm 16, 18 for the insertion of the particular fastening element 46, 48 can be arranged at a distance/off-center with respect to a center point of a base face of the receiving hole 49 of the particular clamping arm body 20, 22. Alternatively or additionally, a threaded hole for the screwing in of the particular fastening element 46, 48 can be arranged in each engagement element 42, 44 at a distance/off-center with respect to a longitudinal center axis of the engagement element 42, 44. Advantageously, the engagement elements 42, 44 thus can be mounted only in a correct orientation by the fastening elements 46, 48 and therefore cannot be mounted incorrectly.

Particularly preferably, each engagement element 42, 44 is connected to the clamping arm body 20, 22 of the particular clamping arm 16, 18 in such a way that the engagement element is sealed by a sealing element 50, 52. The sealing elements 50, 52 can, for example, be in the form of O-rings. Each sealing element 50, 52 can be arranged between the particular engagement element 42, 44 and the particular clamping arm body 20, 22. Each sealing element 50, 52 can prevent the ingress of liquid, germs, etc. into a gap between the particular engagement element 42, 44 and the particular clamping arm body 20, 22, thus advantageously improving hygiene.

Preferably, each fastening element 46, 48 can be connected to the clamping arm body 20, 22 of the particular clamping arm 16, 18 in such a way that the fastening element is sealed by a sealing element 54, 56. The sealing elements 54, 56 can, for example, be in the form of O-rings. Each sealing element 54, 56 can be arranged between the particular fastening element 46, 48 (e.g., under a screw head) and the particular clamping arm body 20, 22. Each sealing element 54, 56 can prevent the ingress of liquid, germs, etc. into a gap between the particular fastening element 46, 48 and the particular clamping arm body 20, 22, thus advantageously improving hygiene.

The centering element 58 is configured and arranged for centering the container B. Specifically, the centering element 58 is arranged, preferably immovably, between the clamping arm pair 16, 18.

The centering element 58 has the receptacle 60. The receptacle 60 is configured to receive part of the support ring T and to support the support ring T. The container B with part of its support ring T positioned in the receptacle 60 can be positioned by the centering element 58 such that the container is centered between the clamping arms 16, 18.

The receptacle 60 can extend around an outer lateral face of the support ring T of the container B, e.g., with respect to a horizontal plane or an orientation plane of the centering element 58 or a plane perpendicular to a vertical axis of the container B.

Preferably, the container B with part of its support ring T positioned in the receptacle 60 can be positioned by the centering element 58 such that the container is centered below the processing device, e.g., closure head 15 (see FIG. 2). For example, the processing device/the closure head 15 can have a central vertical axis which can align with a central vertical axis of the container B centered by the centering element 58, or the two central vertical axes can be identical/collinear.

Preferably, the receptacle 60 can be ring-segment-shaped. The receptacle 60 can form a forked section of the centering element 58. The receptacle 60 is preferably arranged on a front face of the centering element 58. Preferably, the receptacle 60 can be arranged on a top side of the centering element 58.

For example, the receptacle 60 can have a base face 62 for supporting the support ring T from below and a side wall face 64 for supporting the support ring T laterally. The base face 62 and the side wall face 64 can together form a step shape/shoulder shape of the receptacle 60 on the centering element 58. The base face 62 can be ring-segment-shaped, for example. The side wall face 64 can be ring-segment-shaped, for example.

To position the container B such that it is centered between the two clamping arms 16, 18 and optionally centered below a processing device (e.g., closure head 15—see FIG. 2), an outer lateral face of the support ring T can be pressed against the side wall face 64 of the receptacle 60. The pressing can preferably be effected by the clamping arms 16 and 18, preferably by the supporting sections 24 and 26, particularly preferably by the contact faces 32 and 34. These can preferably press against a container neck section directly below the container B and thus press part of the outer lateral face of the support ring T against the side wall face 64. Preferably, the container B thus held such that it is centered can then be processed, e.g., closed, by the processing device.

Preferably, the container B is prevented from rotating or held for torque support by the clamping device 14. For example, the container B can be prevented from rotating by the engagement elements 42, 44. As already mentioned, the engagement elements 42, 44 can engage in, preferably cut into, the container B, preferably directly below the support ring T.

Alternatively or additionally, the rotation prevention can be achieved, for example, by clamping the support ring T between the side wall face 64 and the base face 62 of the receptacle 60. For example, the side wall face 64 can protrude over the base face 62 and/or be in the shape of a segment of a lateral face of a conical frustum, as shown by way of example in FIG. 6. The side wall face 64 and the base face 62 can be angled, e.g., at an angle <90°, e.g., ≤85°, ≤80°, ≤75°or ≤70°. The support ring T can be clamped between the base face 62 and the side wall face 64 when the support ring T is pressed against the side wall face 64 by the clamping arms 16 and 18, preferably by the supporting sections 24 and 26, particularly preferably by the contact faces 32 and 34.

However, it is alternatively also possible, for example, that the side wall face 64 is shaped as a segment of a cylinder lateral face.

Preferably, the centering element 58 is immovably fastened to a support part 66 of the clamping device 14 (see FIGS. 2 and 5). Preferably, the centering element 58 is fastened to the support part 66 detachably and/or from below, e.g., by a screw connection and/or via a spacer. The clamping arms 16, 18 and the centering element 58 can preferably be arranged below the support part 66.

The support part 66 can, for example, be configured for mounting the clamping device 14. The support part 66 is preferably planar. Preferably, the support part 66 can be in the form of a mounting plate. The support part 66 can attach the clamping device 14 preferably to a movable conveying section (not shown), preferably by a screw connection. For example, the support part 66 can attach the clamping device 14 to a rotatable part of a container transport carousel or of a container processing carousel, preferably a closure carousel. Preferably, the support part 66 can be mounted on the movable conveying section, e.g., the rotatable part, from below. The support part 66 can be mounted on a support of the container transport and/or container processing apparatus 10 by overhead mounting.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all features of independent claim 1 and, for example, independently of the features relating to the presence and/or the configuration of the clamping arm pair and/or of the centering element of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 container transport and/or container processing apparatus
12 station
14 clamping device
15 closure head
16 clamping arm
18 further clamping arm
20 clamping arm body
22 further clamping arm body
24 supporting section
26 further supporting section
28 supporting face
30 further supporting face
32 contact face
34 further contact face
36 connecting body
38 further connecting body B container
40 shaft T support ring
42 engagement element V container closure
44 further engagement element
46 fastening element
48 further fastening element
49 receiving hole
50 sealing element
51 fastening hole
52 further sealing element
54 sealing element
56 sealing element
58 centering element
60 receptacle
62 base face
64 side wall face
66 support part

What is claimed is:

1. A clamping device for holding a container at a support ring of the container for a container transport and/or container processing apparatus, wherein the clamping device comprises:
a clamping arm pair having two clamping arms which can be moved relative to one another, for supporting the support ring of the container from below; and
a centering element for centering the container, wherein the centering element is arranged between the clamping arm pair and has a receptacle for partially receiving and supporting the support ring.

2. The clamping device according to claim 1, wherein at least one of the following is met:
the clamping device is a neck handling clamping device;
the two clamping arms can be pivoted relative to one another;
the centering element is immovably fastened to a support part of the clamping device;
the centering element is immovably arranged between the clamping arm pair; and
the centering element and the receptacle are configured and arranged for centered positioning of the container between the two clamping arms.

3. The clamping device according to claim 1, wherein at least one of the following is met:
the receptacle is ring-segment-shaped;
the receptacle forms a forked section of the centering element;
the receptacle is shaped to partially extend around an outer lateral face of the support ring;
the receptacle is formed as a step or a shoulder on the centering element;
the receptacle is arranged on a front face of the centering element; and
the receptacle is arranged on a top side of the centering element.

4. The clamping device according to claim 1, wherein:
the receptacle has a base face for supporting the support ring from below and a side wall face for supporting the support ring laterally.

5. The clamping device according to claim 4, wherein at least one of the following is met:
the base face is ring-segment-shaped;
the side wall face is ring-segment-shaped;
the side wall face is shaped substantially as a segment of a lateral face of a conical frustum;
the side wall face protrudes; and
the side wall face and the base face are angled relative to one another in order to clamp the support ring between the base face and the side wall face.

6. The clamping device according to claim 1, wherein:
the two clamping arms each have a supporting section for supporting the support ring.

7. The clamping device according to claim 6, wherein at least one of the following is met:
the supporting section is at least one of curved and hook-shaped:
the supporting section of each clamping arm is arranged at a free end of the respective clamping arm;
the supporting sections are directed towards the receptacle;
the supporting sections each have a top supporting face for supporting the support ring from below; and
the supporting section each have a vertically oriented contact face for contacting a neck region of the container directly below the support ring in order to press the support ring into the receptacle of the centering element.

8. The clamping device according to claim 7, wherein at least one of the following is met:
the supporting faces are arranged at the same height as a base face of the receptacle of the centering element; and
the contact faces are directed towards the receptacle.

9. The clamping device according to claim 1, wherein:
the two clamping arms each comprise a clamping arm body and an engagement element, wherein the engagement elements are configured to engage in the container.

10. The clamping device according to claim 9, wherein at least one of the following is met:
the engagement element is a cutting element or a spike;
the engagement elements are configured to cut into the container;
the engagement element of each clamping arm is detachably fastened to or in the clamping arm body of the respective clamping arm;
the engagement elements are identical parts;
the engaging elements are held in a receiving hole of the clamping arm body of the respective clamp arm in a form-fitting manner that prevents them from rotating,
the engagement elements are arranged opposite one another;
the engaging elements are each connected to the clamping arm body in a sealed manner by means of a sealing element;
the engagement elements are arranged at a height below a base face of the receptacle of the centering element for engagement in a neck region of the container directly below the support ring;
the engagement elements are arranged on a longitudinal inner side of the clamping arm body of the respective clamping arm; and
the engagement elements are arranged at a distance from a free end of the respective clamping arm.

11. A container processing apparatus, wherein the container processing apparatus comprises:
at least one processing station having a processing device and having a clamping device according to claim 1.

12. The container processing apparatus of claim 11, wherein at least one of
the container processing apparatus is a container closure apparatus for closing containers;
the at least one processing station is a closure station;
the processing device is a closure head; and
the receptacle of the centering element is arranged for centered positioning of the container below the processing device.

13. A method for operating a clamping device according to claim 1, wherein the method comprises:
holding a container at a support ring of the container using the clamping device, wherein the two clamping arms support the support ring from below and the support ring is partially received in the receptacle of the centering element.

14. The method according to claim 13, further comprising:
positioning the container such that the container is centered between the two clamping arms and/or centered below a processing device by applying an outer lateral face of the support ring against a side wall face of the receptacle.

15. The method according to claim 13, further comprising:
preventing the held container from rotating by at least one of the following:
clamping the support ring between a side wall face of the receptacle and a base face of the receptacle; and
engaging in the container using engagement elements of the two clamping arms.

16. The method according to claim 13, further comprising:
replacing engagement elements for engaging in the container to prevent the container from rotating, the engagement elements being detachably fastened to clamping arm bodies of the two clamping arms.

17. The method according to claim 13, wherein:
the support ring is a neck ring.

18. The method according to claim 14, wherein at least one of:
the processing device is a closure head for closing the container;
the applying comprises pressing the outer lateral face of the support ring against the side wall face of the receptacle; and
processing or closing the held and positioned container using the processing device.

19. The method according to claim 15, wherein at least one of:
the support ring is clamped between the side wall face of the receptacle and the base face of the receptacle, via a side wall face of the receptacle which is substantially shaped as a segment of a lateral face of a conical frustum and/or with a protruding side wall face;
the engaging in comprises cutting into the container using the engagement elements; and
the engaging in the container using the engagement elements is directly below the support ring.

20. The method according to claim 16, wherein at least one of:
the engagement elements are for cutting into the container to prevent the container from rotating; and
sealing between the engagement elements and the clamping arm bodies using at least one sealing element.
